(19) United States
(12) Patent Application Publication
(10) Pub. No.: US 2001/0022432 A1
(43) Pub. Date: Sep. 20, 2001

(54) Adjustable suspension system

(76) Inventor: Marc Hebert, St-Hippolyte (CA)

Correspondence Address: Mr. Marc HEBERT, C/o PROTECTIONS EQUINOX INT'L INC., Suite 224, 4480 Cote-de-Liesse, Ville Mont-Royal, QC, H4N 2R1, CA

(21) Appl. No.: 09/776,731

(22) Filed: Feb. 6, 2001

(30) Foreign Application Priority Data
Mar. 15, 2000 (CA) 2,302,842

(51) Int. Cl. B60P 1/00; B60S 9/00; B60G 17/00

(52) U.S. Cl. 280/6.159

(57) ABSTRACT

The adjustable suspension system for cargo vehicles of this invention includes of a cargo bed, at least two coaxial wheels and an adjustable suspension member equipped with a pneumatic system. The adjustable suspension member includes a pivotal axle parallel to the wheel axis, a rigid plate mounted under to the cargo bed, a movable support attached to the pivotal axle, an actuating member located between the movable support and the plate, lateral arms essentially perpendicular to the axle and attached at one of their extremities to a respective end of the axle and at the other extremity to a spindle connected to each wheel. The basic mechanism of these components allows for controlled change of the air pressure in the actuating member to position the cargo bed in a transport or a loading position with greater efficiency and maneuverability while leaving the greatest clearance possible under the cargo bed. This adjustable suspension system also enables the pivotal axle to also act as a torsion bar in order to provide greater suspension to the cargo bed and its load.

### FIELD OF THE INVENTION

This invention relates to the field of suspension systems, and more particularly to adjustable suspension systems of cargo beds of cargo transport vehicles.

### BACKGROUND OF THE INVENTION

Many types of adjustable suspension systems for cargo transport vehicles already exist. For example, there are systems for hoisting vehicles on to cargo beds using winches. These systems are well known but their cargo beds are not capable of lowering themselves to the point where they touch the loading surface, necessitating the additional help of temporary access ramps or gangways to guide or align the wheels of the vehicle to be hauled. Other systems must angle the end of the cargo bed downward with a leverage device. In any event, these procedures require that a fair degree of space is available between the vehicle to be hauled and the hauler and failing this may very well require a vertical winch. Other systems are equipped with hoists. Given that these systems allow for the raising of various objects, they all face limitations dictated by the weight and dimensions of the latter.

Another suspension system for cargo vehicles was described in U.S. Pat. No. 5,887,880 issued to Mullican on Mar. 30, 1999. This system, which uses an air bag to adjust the position of the cargo bed, provides a non-optimal torque due to its position relative to the other parts of the system. In addition, the mechanism is very close to the road surface when in the transport position, thus limiting the clearance available under the cargo bed and rendering the latter more vulnerable to obstructions, which may be encountered on the road.

### OBJECTS OF THE INVENTION

A general object of the present invention is to provide an adjustable suspension system that obviates the above-mentioned disadvantages.

Another object of the present invention is to provide an adjustable suspension system that allows for better use of the pivotal axle as a torsion bar to ensure better suspension of the cargo bed and its transport load.

A further object of the present invention is to provide an adjustable suspension system, which will allow for greater clearance between the cargo bed and the road surface for greater maneuverability of the cargo bed on different road surfaces.

Still another object of the present invention is to provide an adjustable suspension system allowing for loading without the need for temporary accessories.

Still a further object of the present invention is to provide an adjustable suspension system allowing for fast, simple and safe loading with the fewest parts possible, in order to be lighter and much more affordable.

Yet another object of the present invention is to provide an adjustable suspension system allowing for practicable loading in a tight space, considering said space excluding or other than that occupied by the transport vehicle at the time the cargo bed is adjusted to the elevated transport position.

Yet further object of the present invention is to provide an adjustable suspension system, which allows for loading with a section of the cargo bed descending to the road surface.

Other objects and advantages of the present invention will become apparent from a careful reading of the detailed description provided herebelow, with appropriate reference to the accompanying drawings.

### SUMMARY OF THE INVENTION

According to one aspect of the present invention, there is provided an adjustable suspension system for cargo vehicle comprising:

a cargo bed of a specific width having a front end and a rear end;

at least one pair of fixed supports, each of the two fixed supports being located at a respective side of the cargo bed and relatively aligned to the other in a direction of the width of the cargo bed;

an adjustable suspension member to suspend the cargo bed on the fixed supports, the suspension member being adjustable between a raised transport position in which the cargo bed is essentially parallel to a road surface for the vehicle and an inclined loading position in which the rear of the cargo bed generally rests on the road surface; the adjustable suspension member includes:

a rigid plate frontwardly mounted under the cargo bed relative to the fixed supports;

a pivotal axle rotatably mounted on the cargo bed, the axle being adjacent to the rigid plate, parallel to the direction of the width of the cargo bed and essentially extending along the width;

a movable support linked to the pivotal axle;

an actuating member located between the rigid plate and the movable support; and

a pair of lateral arms being essentially perpendicular to the pivotal axle and having a front end attached to a respective end of the axle and a rear end attached to a respective of the fixed supports, in a manner that when the relative air pressure in the actuating member varies from high to low, the movable support revolves around the pivotal axle towards the rigid plate and the lateral arms also revolve around the pivotal axle in such a manner that the cargo bed inclines until its rear end rests on the road surface; and a pneumatic system to control the air pressure in the actuating member.

Preferably, the fixed supports are coaxial wheels, each of the wheels being mounted on a spindle attached to the rear end of a respective of the lateral arms.

Preferably, the movable support is essentially located under the rigid plate, the movable support and the rigid plate are rearwardly located relative to the pivotal axle.

Preferably, the rigid plate, the movable support and the actuating member are essentially centered along the width of the cargo bed.

Preferably, the pneumatic system includes:

a compressor;

a compressed air storage tank;

a control system to control the compressor;

an air hose between the storage tank and the actuating member;

a supply valve in the air hose normally in the closed position and adjacent to the compressed air storage tank to allow for inflation of the actuating member; and

an exhaust valve normally in the closed position and adjacent to the actuating member allowing for expulsion of air from the same.

Preferably, the lateral arms are essentially positioned mid-way between the rigid plate and the movable support when the cargo bed is in the raised position.

Preferably, the pivotal axle is mounted on the cargo bed via a plurality of bearing blocks uniformly spaced along the width of the latter.

Preferably, the lateral arms are outwardly located at a respective side of the cargo bed to allow for the wheel spindles to pass above the cargo bed while the latter moves from the transport position to the loading position.

Preferably, the suspension system further comprises a pair of wheel fenders, each being attached to the rear end of its respective of the lateral arms, and a pair of shock absorbers pivotally secured at a first extremity to the cargo bed and at a second extremity to corresponding determined moving pieces of the system, on each side of the actuating member.

Preferably, the corresponding determined moving pieces being the rear end of the lateral arms.

Alternatively, the corresponding determined moving pieces being a respective side of the movable support.

Preferably, the rigid plate is essentially located beneath the movable support, the rigid plate and the movable support being frontwardly located in relative to the pivotal axle.

Preferably, the actuating member has an upper and lower parts pivotally mounted around the direction of the width of the cargo bed on the rigid plate and the movable support respectively.

Preferably, the actuating member is an air bag or an air cylinder.

Preferably, the rigid plate, the actuating member and the movable support of the adjustable suspension member are adjacent to a first end of the pivotal axle, the adjustable suspension member further includes:

a second rigid plate frontwardly mounted under the cargo bed relative to fixed supports;

a second movable support linked to the pivotal axle;

a second actuating member located between the second rigid plate and the second movable support, all three being adjacent to a second end of the pivotal axle; in such a way that when the relative air pressure in both actuating members varies from high to low, the movable supports revolve around the pivotal axle toward their respective rigid plates and the lateral arms also revolve around the pivotal axle in such a way that the cargo bed inclines until its rear end rests on the road surface.

### BRIEF DESCRIPTION OF THE DRAWINGS

In the annexed drawings, like reference characters indicate like elements throughout.

FIG. 1 is an elevation view showing a first embodiment of an adjustable suspension system according to the present invention, in the raised or transport position as indicated by solid lines, and in the lowered or loading position as indicated by dotted lines;

FIGS. 2 and 3 are enlarged side views of the embodiment of FIG. 1 in the raised and lowered positions respectively;

FIGS. 4 and 5 are plan and back views of the embodiment of FIG. 1;

FIG. 6 shows a schematic diagram of the functioning of the pneumatic system of the embodiment of FIG. 1.

FIG. 7 is a view similar to FIG. 4 showing a two adjustable suspension member configuration of the embodiment of FIG. 1;

FIGS. 8 and 9 are similar views of FIGS. 2 and 3 respectively, showing a second embodiment of the adjustable suspension system according to the present invention;

FIG. 10 is a view similar to FIG. 6 showing a schematic diagram of the functioning of the pneumatic system of the configuration of FIG. 7;

FIG. 11 is a view similar to FIG. 2 of a third embodiment of the adjustable suspension system according to the present invention showing pivot connections of the actuating member with the rigid plate and with the movable support; and

FIG. 12 is a bottom view of the embodiment of FIG. 11.

### DETAILED DESCRIPTION OF THE PREFERRED EMBODIMENTS

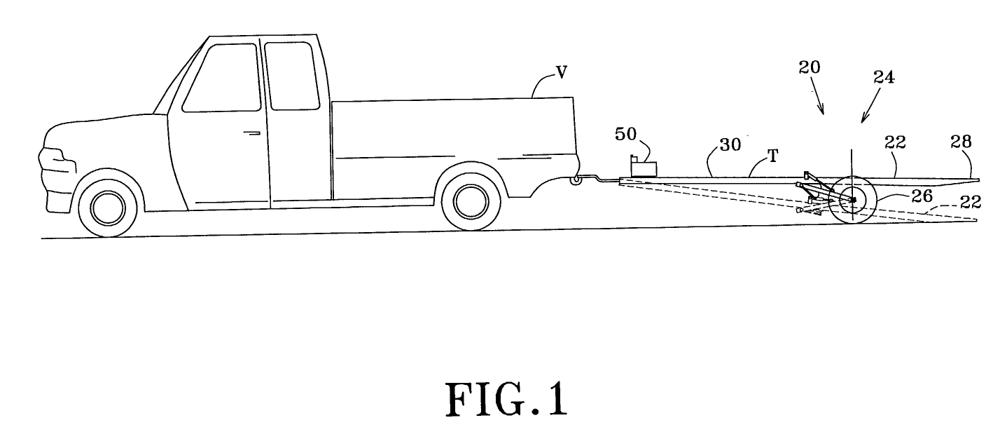

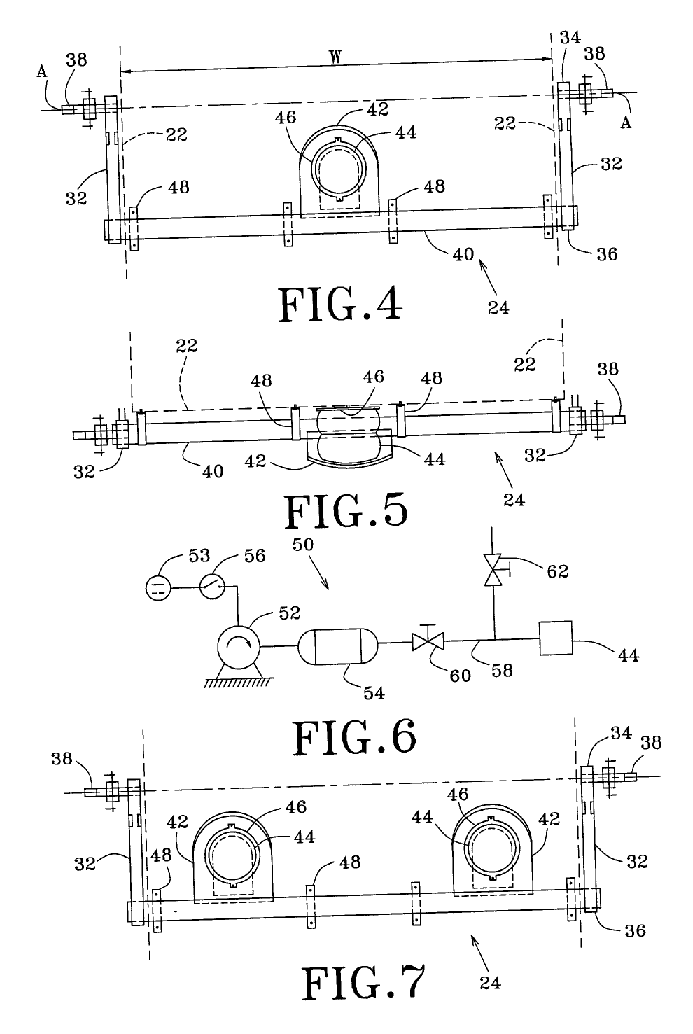

Referring to FIG. 1, there is shown a first embodiment 20 of an adjustable suspension system according to the present invention for a cargo vehicle, preferably a trailer T, that includes a cargo bed 22 of a width W (see FIGS. 4 and 5) and essentially parallel to the roadway R when in a raised position for transport, an adjustable suspension member 24, preferably pneumatic, mounted beneath the cargo bed 22 and to a pair of fixed supports, preferably coaxial wheels 26. The adjustable suspension member 24 allows for the cargo bed 22 to be moved between a raised position for transport and a lowered position for loading represented by solid and dotted lines respectively in FIG. 1. In the latter position, the rear end 28 of the cargo bed 22 rests on the road surface R to facilitate the loading of the trailer T.

The wheels 26 are preferably positioned mid-way between the rear 28 and the front 30 of the cargo bed 22, thus the axis of rotation A (see FIGS. 4 and 5) is in the direction of the width W of the cargo bed 22, and each wheel 26 is preferably and respectively located on the exterior of each side of the cargo bed 22. According to the relative diameter of the wheels 26, the latter could be located directly beneath the cargo bed 22 if they are small enough.

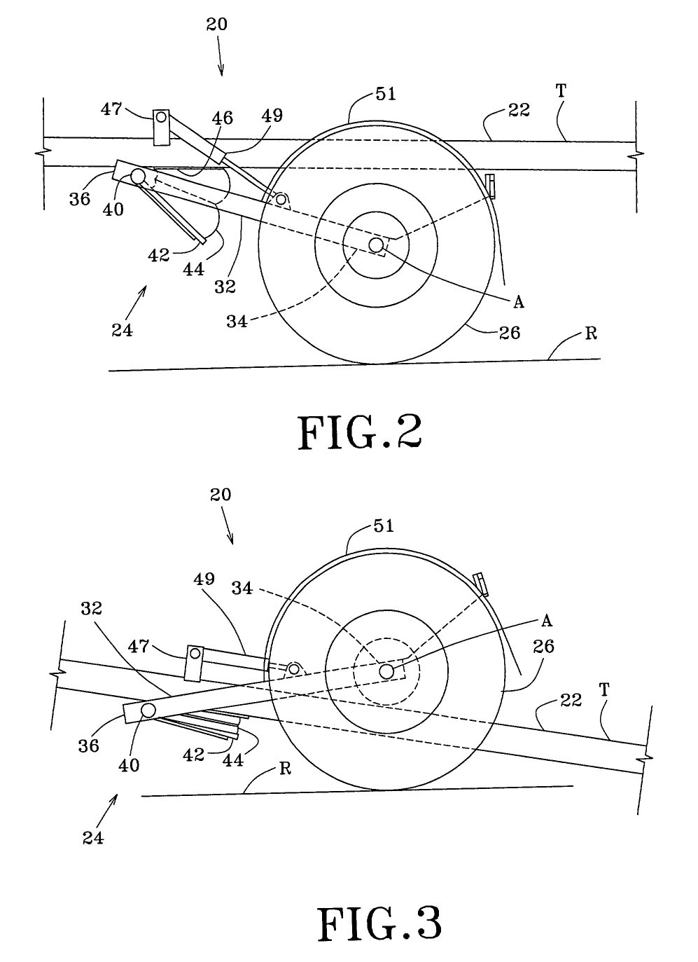

Referring to FIGS. 2 to 5, on each side of the cargo bed 22 and to the outside of the same there is a lateral arm 32 having a front end 36 and a rear end 34. A spindle 38 (see FIGS. 4 and 5) specifically adapted to accommodate a respective wheel 26 is mounted on the rear end 34 of each lateral arm 32. The front end 36 of each lateral arm 32 is preferably rigidly attached to a respective end of a pivotal axle 40 (see FIGS. 4 and 5). Preferably, each lateral arm 32 is essentially located perpendicular to the pivotal axle 40 which itself is precisely parallel to the axis A of the wheels 26 and in front of the latter. Preferably, a movable support 42 is rigidly secured to the center portion of the pivotal axle 40, and preferably radially oriented relative to the same, above which an inflatable actuating member 44 is deployed. The actuating member 44 is restrained from above by a rigid and reinforcing plate 46 itself secured to the cargo bed 22. The movable support 42, the actuating member 44 and the rigid plate 46 are preferably adjacent and to the rear relative to the pivotal axle 40, and all housed in front of the axis A of coaxial wheels 26.

FIG. 2 shows the adjustable suspension member 24 in the raised transport position with the cargo bed 22 located above axis A of the wheels 26 and the actuating member 44, preferably an air bag, inflated under high air pressure. FIG. 3 shows the adjustable suspension member 24 in the lowered loading position with the cargo bed 22 now located below the wheel axis A of the wheels 26 and the actuating member (air bag) 44 deflated and compressed under the weight of the cargo bed 22 and its load. FIG. 2 also illustrates the preferably relative mid-elevation of the lateral arms 32 with regard to the movable support 42 and the rigid plate 46.

As seen in FIGS. 4 and 5, the pivotal axle 40 is held against and beneath the cargo bed 22, preferably by a series of bearing blocks 48 uniformly spaced along the width W of the cargo bed 22. It is equally obvious that the pivotal axle 40 essentially extends across the total width of the cargo bed 22. In addition, the movable support 42, the air bag 44 and the rigid plate 46 are essentially centered along the width W of the cargo bed 22. A pair of shanks 47 (only one shank is seen in FIGS. 2 and 3) completes the suspension system 20, each shank 47 is vertically and rigidly secured to a respective edge of the cargo bed 22, approximately above the pivotal axle 40. A pair of shock absorbers 49 link the top of each shank 47 to a respective lateral arm 32, preferably closer to its rear end, to absorb shock while in transport.

Preferably, a wheel fender 51 covers each wheel 26 when the trailer T is in the raised position for transport to protect the load against road detritus, and is attached to the rear end 34 of its respective lateral arm 32.

The pneumatic system 50 of the adjustable suspension member 24, as represented in its simplest form in FIG. 6, is comprised of a compressor 52, preferably powered by the battery of the hauling vehicle V pulling the trailer T, an air storage tank 54, a control system 56, preferably a simple switch, to control the compressor 52, an air hose 58 between the air storage tank 54 and the air bag 44, a supply valve 60 in the air hose 58 normally in the closed position adjacent to the air storage tank 54 to inflate the bag 44, and an exhaust valve 62 also normally in the closed position adjacent to the bag 44 to allow for the expulsion of air from the latter. Preferably, the supply valve 60 and the exhaust valve 62 are combined to a three way valve located near the control switch 56. It will be understood by one skilled in the art that the pneumatic system can be much more complex and include different safety features connected to an electronic control, making it more automatically self-controlled.

Thus the suspension system 20 supports the cargo bed 22 on wheels 26 and can be adjusted to go from the raised transport position to the lowered or inclined position of loading, by lowering the accumulated air pressure inside the air bag 44. Such a change forces the movable support 42 to revolve around the pivotal axle 40 toward the rigid plate 46 while simultaneously forcing the lateral arms 32 to also revolve around the pivotal axle 40 and thereby engage the spindles 38 to rise above the cargo bed 22; all this a result of the weight of the cargo bed 22 and its load. The direct result is the movement of the cargo bed 22 from a raised generally horizontal position and parallel with respect to the road R, to a lowered and inclined position with the rear end 28 of the cargo bed 22 touching the road to allow for easy loading of the trailer T. This suspension system 20 offers improved suspension as the pivotal axle 40 acts as a torsion bar owing to the amount of torsion created by the relatively large horizontal distance between axle A of the wheels 26 and the pivotal axle 40.

Referring to FIG. 7, the suspension 24 can be comprised of two actuating members 44, each located in close proximity to its respective end of the pivotal axle 40, thereby doubling corresponding parts of the adjustable suspension member 24, in order to allow for a heavier load as well as offer added protection in the event that there is a problem with just a single air bag 44. For that case, the pneumatic system 50 of the adjustable suspension member 24 is represented in its simplest form in FIG. 10 and allows for efficient air inflating of the air bags 44 under a corresponding heavy load, with each air bag 44 having its own supply valve 60 and exhaust valve 62 mounted on its hose 58. Similarly, the suspension system 20 can have more than one pair of coaxial wheels 26 (not shown) to also support a heavier load.

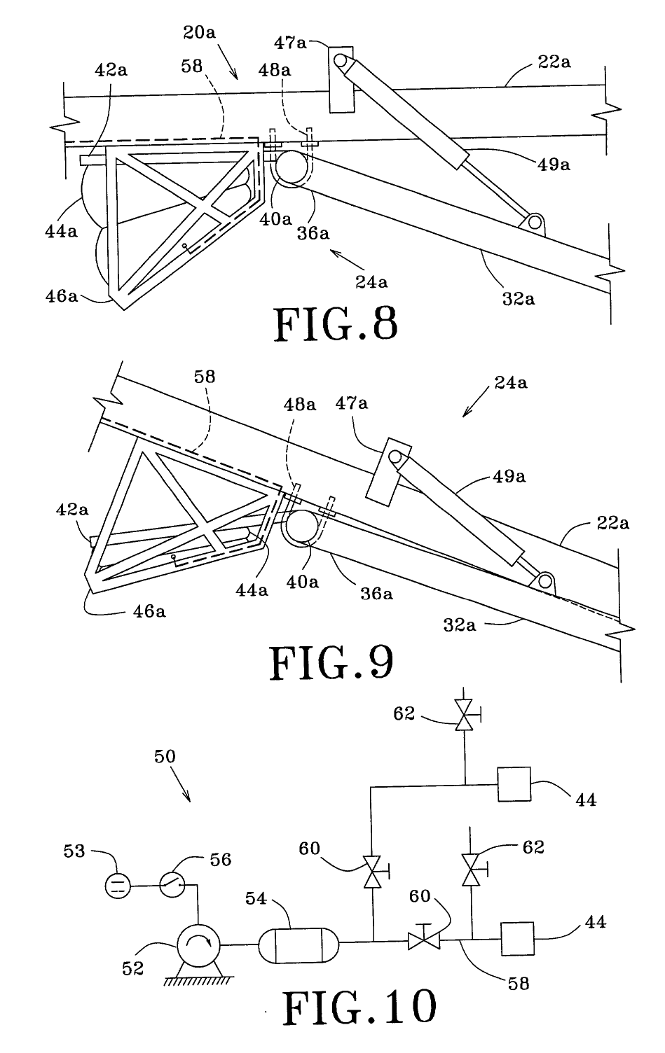

FIGS. 8 and 9 show a second embodiment 20a of the suspension system. The center portion of the pivotal axle 40a of this system 20a is rigidly linked to the movable support 42a beneath which the actuating member 44a is deployed. The latter is also attached from beneath to the rigid plate 46a, which in turn is secured to the cargo bed 22a. In this embodiment 20a, the movable support 42a, the actuating member 44a and the rigid plate 46a are moved relative to the first embodiment, now being adjacent to and in front of the pivoting axle 40a.

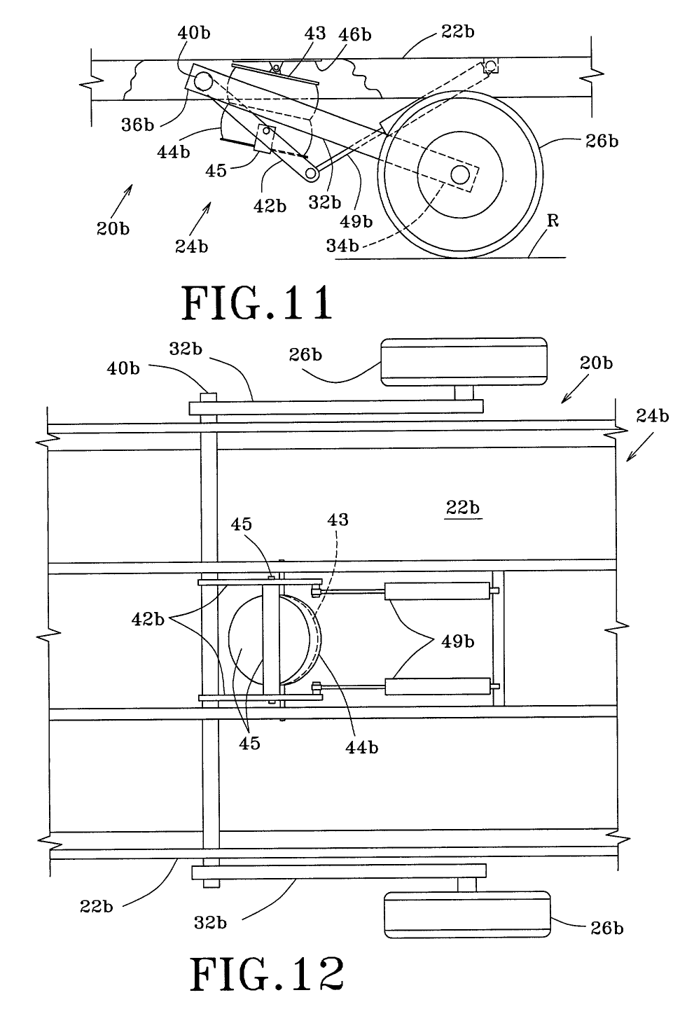

Referring to FIGS. 11 and 12, the actuating member 44b of the suspension member 24b of a third embodiment 20b of the suspension system of the present invention is pivotally mounted at its upper 43 and lower 45 parts to the rigid plate 46b and the movable support 42b respectively (represented by two parallel brackets secured to the pivot axle 40b connected to the arms 32b with their respective wheel 26b). Both the upper 43 and lower 45 parts of the actuating member 44b are pivotally mounted around the direction of the width W of the cargo bed 22b. This pivot free mounting is preferable for a better functioning and life duration of the air bag 44b. In case of an air cylinder, this is almost required. Alternatively, as shown in FIGS. 11 and 12, the shock absorbers 49b could also be mounted closer to the air bag 44b under the bed 22b, on each side thereof on a respective movable support 42b, instead of being at the sides of the cargo bed 22.

The suspension system 20 of the present invention can also be used in various similar applications such as towing pleasure craft, forklift trucks, backhoe, wheel and track loaders with buckets (representing the cargo bed) or any other similar application.

Although embodiments of the invention have been illustrated in the accompanying drawings and described in the foregoing detailed description, it will be understood that the invention is not limited to the embodiments disclosed, but is capable of numerous rearrangements, modifications, and substitutions without departing from the scope of the invention.

I claim:

1. An adjustable suspension system for cargo vehicle comprising:
a cargo bed of a specific width having a front end and a rear end;
at least one pair of fixed supports, each of the two fixed supports being located at a respective side of the cargo bed and relatively aligned to the other in a direction of the width of the cargo bed;
an adjustable suspension member to suspend the cargo bed on the fixed supports, the suspension member being adjustable between a raised transport position in which the cargo bed is essentially parallel to a road surface for the vehicle and an inclined loading position in which the rear of the cargo bed generally rests on the road surface; the adjustable suspension member includes:
a rigid plate frontwardly mounted under the cargo bed relative to the fixed supports;
a pivotal axle rotatably mounted on the cargo bed, the axle being adjacent to the rigid plate, parallel to the direction of the width of the cargo bed and essentially extending along the width;
a movable support linked to the pivotal axle;
an actuating member located between the rigid plate and the movable support; and
a pair of lateral arms being essentially perpendicular to the pivotal axle and having a front end attached to a respective end of the axle and a rear end attached to a respective of the fixed supports, in a manner that when the relative air pressure in the actuating member varies from high to low, the movable support revolves around the pivotal axle towards the rigid plate and the lateral arms also revolve around the pivotal axle in such a manner that the cargo bed inclines until its rear end rests on the road surface; and a pneumatic system to control the air pressure in the actuating member.

2. A system as defined in claim 1, wherein the fixed supports are coaxial wheels, each of the wheels being mounted on a spindle attached to the rear end of a respective of the lateral arms.

3. A system as defined in claim 2, wherein the movable support is essentially located under the rigid plate, the movable support and the rigid plate are rearwardly located relative to the pivotal axle.

4. A system as defined in claim 3, wherein the rigid plate, the movable support and the actuating member are essentially centered along the width of the cargo bed.

5. A system as defined in claim 2, wherein the pneumatic system includes:
a compressor;
a compressed air storage tank;
a control system to control the compressor;
an air hose between the storage tank and the actuating member;
a supply valve in the air hose normally in the closed position and adjacent to the compressed air storage tank to allow for inflation of the actuating member; and
an exhaust valve normally in the closed position and adjacent to the actuating member allowing for expulsion of air from the same.

6. A system as defined in claim 4, wherein the lateral arms are essentially positioned mid-way between the rigid plate and the movable support when the cargo bed is in the raised position.

7. A system as defined in claim 2, wherein the pivotal axle is mounted on the cargo bed via a plurality of bearing blocks uniformly spaced along the width of the latter.

8. A system as defined in claim 2, wherein the lateral arms are outwardly located at a respective side of the cargo bed to allow for the wheel spindles to pass above the cargo bed while the latter moves from the transport position to the loading position.

9. A system as defined claim 8, further comprising a pair of wheel fenders, each being attached to the rear end of its respective of the lateral arms.

10. A system as defined in claim 2, further comprising a pair of shock absorbers pivotally secured at a first extremity to the cargo bed and at a second extremity to corresponding determined moving pieces of the system, on each side of the actuating member.

11. A system as defined in claim 10, wherein the corresponding determined moving pieces being the rear end of the lateral arms.

12. A system as defined in claim. 10, wherein the corresponding determined moving pieces being a respective side of the movable support.

13. A system as defined in claim 2, wherein the rigid plate is essentially located beneath the movable support, the rigid plate and the movable support being frontwardly located in relative to the pivotal axle.

14. A system as defined in claim 1, wherein the actuating member having an upper and lower parts pivotally mounted around the direction of the width of the cargo bed on the rigid plate and the movable support respectively.

15. A system as defined in claim 14, wherein the actuating member is an air bag.

16. A system as defined in claim 14, wherein the actuating member is an air cylinder.

17. A system as defined in claim 1, wherein the rigid plate, the actuating member and the movable support of the adjustable suspension member are adjacent to a first end of the pivotal axle, the adjustable suspension member further including:
a second rigid plate frontwardly mounted under the cargo bed relative to fixed supports;
a second movable support linked to the pivotal axle;
a second actuating member located between the second rigid plate and the second movable support, all three being adjacent to a second end of the pivotal axle; in such a way that when the relative air pressure in both actuating members varies from high to low, the movable supports revolve around the pivotal axle toward their respective rigid plates and the lateral arms also revolve around the pivotal axle in such a way that the cargo bed inclines until its rear end rests on the road surface.

18. An adjustable suspension system for cargo vehicle comprising:
a cargo bed of a specific width having a front end and rear end;
at least one pair of fixed supports, each of the two fixed supports being located on a respective side of the cargo bed and relatively aligned to the other in a direction of the width of the cargo bed;
an adjustable suspension member to suspend the cargo bed on the fixed supports, the suspension member being adjustable between a raised transport position in which the cargo bed is essentially parallel to a road surface for the vehicle and an inclined loading position in which the rear of the cargo bed generally rests on the road surface; the adjustable suspension member includes:
a first rigid plate frontwardly mounted under the cargo bed relative to the fixed supports;
a pivotal axle rotatably mounted on the cargo bed, the axle being adjacent to the rigid plate, parallel to the direction of the width of the cargo bed and extending essentially along the width;
a first movable support linked to the pivotal axle;
a first actuating member located between the first rigid plate and the first movable support, all three being adjacent to a first end of the pivotal axle;
a second rigid plate frontwardly mounted under the cargo bed relative to the fixed supports;
a second movable support linked to the pivotal axle;
a second actuating member located between the second rigid plate and the second movable support, all three being adjacent to a second end of the pivotal axle;
a pair of lateral arms being essentially perpendicular to the pivotal axle and having a front end attached to a respective end of the axle and a rear end attached to a respective of the fixed supports, in a manner that when the relative pressure of the air in the actuating members varies from high to low, the movable supports revolve around the pivotal axle towards their respective rigid plate and the lateral arms also revolve around the pivotal axle in such a manner that the cargo bed inclines until its rear end rests on the road surface; and a pneumatic system to control the air pressure in the actuating members.

19. A system as defined in claim 18, wherein the fixed supports are coaxial wheels, each wheel being mounted on a spindle attached to the rear end of a respective of the lateral arms.

20. A system as defined in claim 19, wherein the movable supports are essentially located under its respective of the rigid plates, the first and second movable supports and the first and second rigid plates are rearwardly located relative to the pivotal axle.

21. A system as defined in claim 18, wherein the pneumatic system includes:
a compressor;
a compressed air storage tank;
a control system to control the compressor;
an air hose between the storage tank and the actuating members;
a supply valve in the air hose normally in the closed position adjacent to the compressed air storage tank to allow for inflation of actuating members; and
an exhaust valve normally in the closed position and adjacent to the actuating members allowing for expulsion of air from the same.

22. A system as defined in claim 18, wherein each actuating member having an upper and lower parts pivotally mounted around the direction of the width of the cargo bed on its respective rigid plate and the movable support respectively.

23. A system as defined in claim 22, wherein the actuating members are air bags.

24. A system as defined in claim 22, wherein the actuating members are air cylinders.
